(19) United States
(12) Patent Application Publication
(10) Pub. No.: US 2013/0242611 A1
(43) Pub. Date: Sep. 19, 2013

(54) Side-Edge Backlight Module

(71) Applicant: YeWen Wang, Shenzhen (CN)

(72) Inventor: YeWen Wang, Shenzhen (CN)

(73) Assignee: Shenzhen China Star Optoelectronics Technology Co. LTD., Shenzhen City, Guangdong (CN)

(21) Appl. No.: 13/509,997

(22) PCT Filed: Mar. 28, 2012
(86) PCT No.: PCT/CN12/73170

§ 371 Date: May 15, 2012

(30) Foreign Application Priority Data
Mar. 19, 2012 (CN) 201210073129.6

(51) Int. Cl. G09F 13/04

(52) U.S. Cl. 362/612

(57) ABSTRACT

The present invention provides a side-edge backlight module, which includes a backlight source that emits blue light, a light guide board, and a fluorescent powder layer. The light guide board includes a light incidence surface. The backlight source is set corresponding to the light incidence surface and is arranged at one side of the light guide board. The fluorescent powder layer is mounted by a bonding layer to the light incidence surface of the light guide board. The bonding layer has an end face that is in contact engagement with the fluorescent powder layer and includes a smooth continuous curved surface. The fluorescent powder layer is set along the curved surface. The fluorescent powder layer is excited by the blue light emitting from the backlight source to generate white light. The white light transmits through the bonding layer to enter the light guide board.

### BACKGROUND OF THE INVENTION

1. Field of the Invention

The present invention relates to the field of liquid crystal displaying, and in particular to a side-edge backlight module.

2. The Related Arts

Liquid crystal display is commonly abbreviated as LCD, of which the working principle is that liquid crystal molecules are interposed between two parallel glass plates and a plurality of vertical and horizontal fine electrical wires is arranged between the two glass plates, whereby the liquid crystal molecules are controlled to change direction by application of electricity in order to refract light to generate images. The liquid crystal display has a variety of advantages, such as compact device size, low power consumption, and being free of radiation, and is thus widely used. Most of the liquid crystal displays that are currently available in the market are backlighting liquid crystal displays, which comprise a liquid crystal panel and a backlight module. The backlight module can be classified as two types, namely side-edge backlight module and direct backlight module, according to the position where light gets incident. The conventional side-edge backlight module generally comprises a backplane, a backlight source, a reflection plate, a light guide board, and optic films that are arranged in the backplane. The current backlight source generally adopts white light-emitting diode (WLED) to replace the conventionally used cold cathode fluorescent lamp (CCFL). In a relative sense, WLED is more environmentally-friendly and more efficient than CCFL.

The conventional WLED is formed by packaging fluorescent powder and light source chip and shows the following shortcomings:

(1) Light that emits from WLED shows an optic path difference when passing through the fluorescent powder, and this leads to severe color deviation.

(2) The white light emitting from WLED, when transmitting through the light guide board of which the surface is flat, may be subjected to refraction due to the optic path extending from a sparse medium into a dense medium, and this leads to concentration of light and thus deteriorates homogenization.

(3) Light mixture often occurs among LEDs and this leads to severe light concentration spots.

(4) WLED, which serves as the backlight source, may easily subject the fluorescent power to heating due to the heat generated by the LED chip during the operation thereof and this leads to light decline and severe reduction of light emission efficiency of the fluorescent powder, thereby affecting light intensity of the module.

To overcome these problems, as shown in FIG. 1, a conventional side-edge backlight module comprises a light source module 100 that emits blue light and a light guide board 200. The light guide board 200 has a light incidence surface on which a fluorescent powder film 300 that, when excited by blue light, emits white light. The fluorescent powder film 300 comprises fluorescent powders and resin. The fluorescent powder film 300 is spaced from the light source module 100 so as to effectively avoid light decline caused by the fluorescent powder being heated. However, the issue of inhomogeneous light mixture is yet not solved and may lead to severe problem of light concentration spot.

### SUMMARY OF THE INVENTION

An object of the present invention is to provide a side-edge backlight module, which effectively removes light concentration spot, provides homogeneous light emission, shows high light intensity, and has an extended lifespan.

To achieve the object, the present invention provides a backlight module, which comprises: a backlight source that emits blue light, a light guide board, and a fluorescent powder layer. The light guide board comprises a light incidence surface. The backlight source is set corresponding to the light incidence surface and arranged at one side of the light guide board. The fluorescent powder layer is mounted by a bonding layer to the light incidence surface of the light guide board. The bonding layer has an end face that is in contact engagement with the fluorescent powder layer and comprises a smooth continuous curved surface. The fluorescent powder layer is set along the curved surface. The fluorescent powder layer is excited by the blue light emitting from the backlight source to generate white light. The white light transmits through the bonding layer to enter the light guide board.

The backlight source comprises a circuit board and a plurality of LED chips that is arranged on the circuit board and is electrically connected to the circuit board to emit blue light. The plurality of LED chips is arranged to face the fluorescent powder layer.

The end face of the bonding layer that is in contact engagement with the fluorescent powder layer comprises a smooth continuous convex curved surface.

The end face of the bonding layer that is in contact engagement with the fluorescent powder layer comprises a smooth continuous concave curved surface.

The efficacy of the present invention is that the present invention provides a side-edge backlight module, which arranges the fluorescent powder layer to be spaced from the backlight source in order to extend the lifespan of the module and the backlight source, reduce the extent of color deviation and which also makes an end face of the bonding layer that is in contact engagement with the fluorescent powder layer a smooth continuous curved surface. The fluorescent powder layer is set along the curved surface so as to achieve more uniform distribution of light, elimination of light concentration spot, and increase of homogenization of the light guide board.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of embodiments of the present invention, with reference to the attached drawings. In the drawings:

FIG. 1 is a schematic view showing a conventional structure of side-edge backlight module;

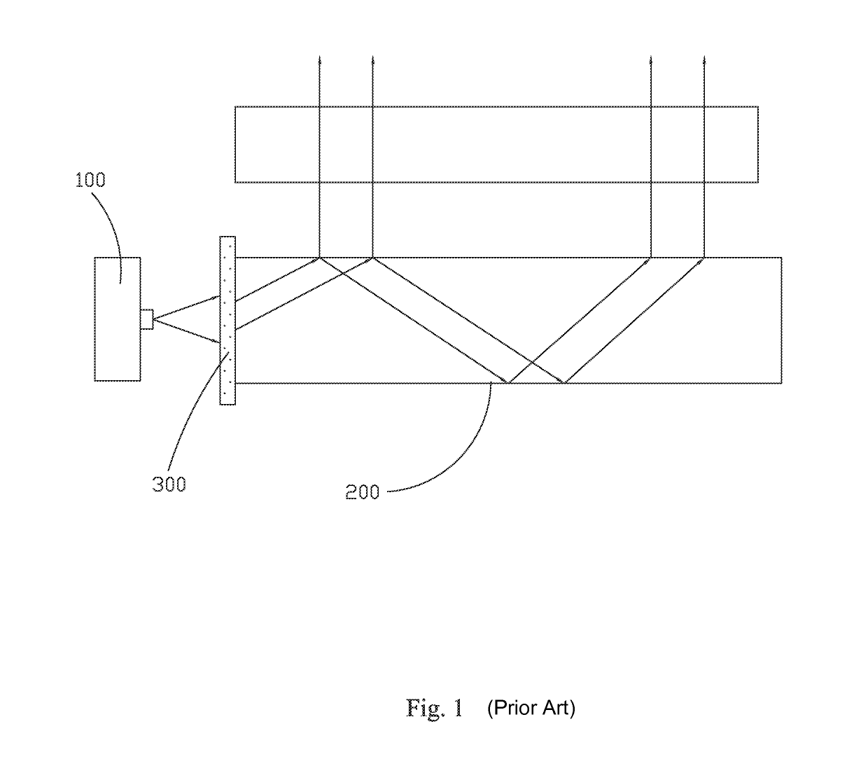

FIG. 2 is a schematic view showing a partial structure of side-edge backlight module according to an embodiment of the present invention; and

FIG. 3 is a schematic view showing a partial structure of side-edge backlight module according to another embodiment of the present invention.

### DETAILED DESCRIPTION OF THE PREFERRED EMBODIMENTS

To further expound the technical solution adopted in the present invention and the advantages thereof, a detailed description is given to preferred embodiments of the present invention and the attached drawings.

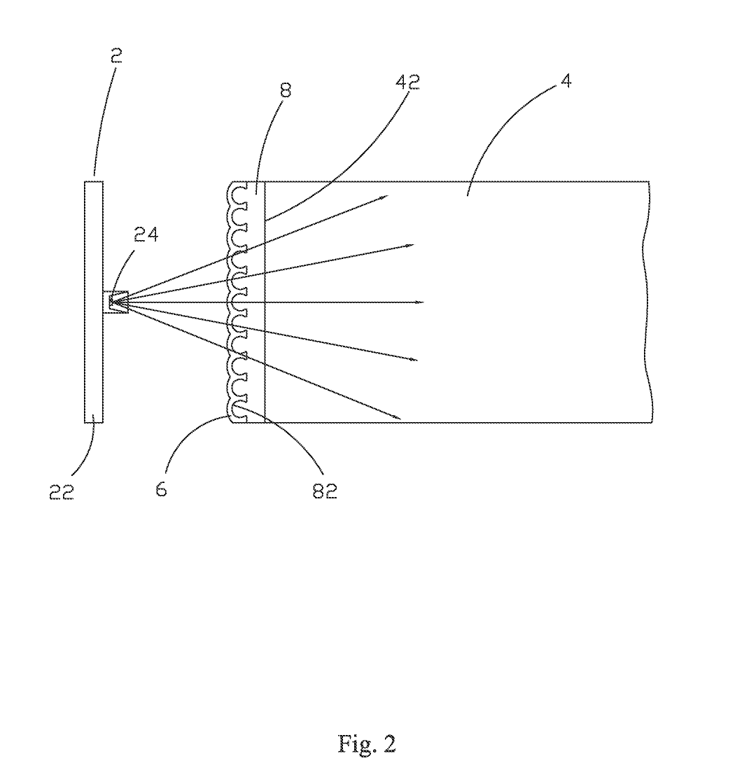

As shown in FIG. 2, the present invention provides a side-edge backlight module, which comprises: a backlight source 2 that emits blue light, a light guide board 4, and a fluorescent powder layer 6. The light guide board 4 comprises a light incidence surface 42. The fluorescent powder layer 6 is mounted by a bonding layer 8 to the light incidence surface 42 of the light guide board 4. The backlight source 2 preferably comprises a circuit board 22 and a plurality of LED chips 24 that is arranged on the circuit board 22 and is electrically connected to the circuit board 22 for emission of blue light. The backlight source 2 is arranged at one side of the light guide board 4 to oppose the light incidence surface 42. The plurality of LED chips 24 of the backlight source 2 is arranged to exactly face the fluorescent powder layer 6 to form a side-edge backlight module.

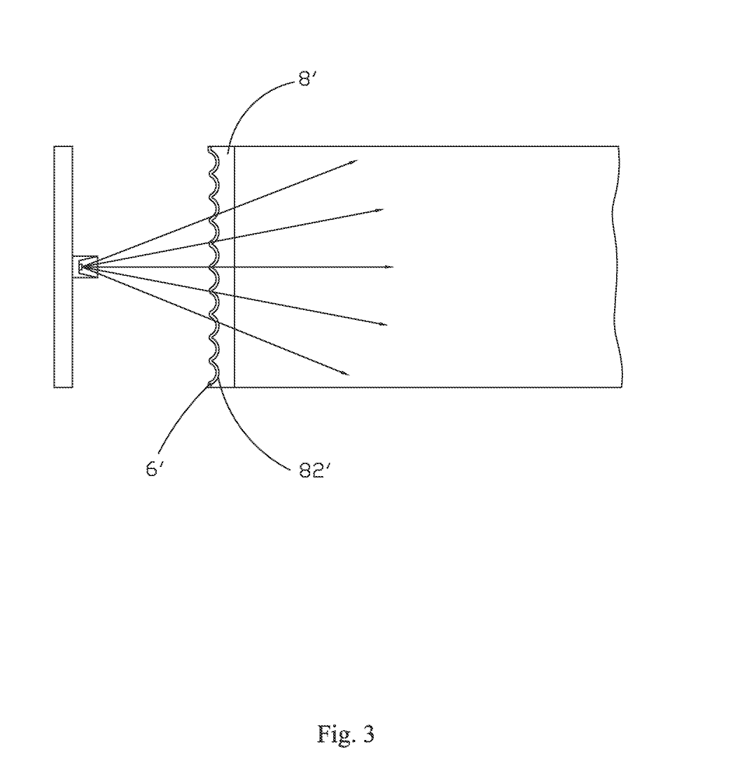

Specifically, the bonding layer 8 has an end face that is in contact engagement with the fluorescent powder layer 6 and is a smooth continuous curved surface. The fluorescent powder layer 6 is set along the curved surface. The fluorescent powder layer 6 is excited by the blue light emitting from the backlight source 2 to generate white light, which transmits through the bonding layer 8 to enter the light guide board 4. The bonding layer 8 is preferably arranged to be light transmitting. In the instant embodiment, the bonding layer 8 has an end face that is in contact engagement with the fluorescent powder layer 6 and is a smooth continuous convex curved surface 82. The arrangement of curved surface helps uniformly distributing light into the light guide board 4, eliminating light concentration spot, improving homogenization of light guiding by the light guide board 4, and thus homogenizing emission of light. In other embodiments, the end face of a bonding layer 8′ that is set in contact engagement with a fluorescent powder layer 6′ comprises a concave curved surface 82′ (see FIG. 3) or curved surfaces of other types.

In the present invention, the backlight source 2 is spaced from the light guide board 4 and arranged at one side of the light guide board 4 so that the backlight source 2 is spaced from the fluorescent powder layer 6 that is arranged on the light guide board 4 and the light source adopts blue light, whereby light intensity is increased, color deviation is reduced, and light color is improved.

In operation, the backlight source 2 emits blue light toward the fluorescent powder layer 6, and the blue light is converted by the fluorescent powder layer 6 into white light. The white light transmits through the curved surface of the bonding layer 8 to be more homogeneously distributed into the light guide board 4 without generating optic path difference and eliminating light concentration spot, thereby ensuring homogenization of light guiding by the light guide board 4.

In summary, the present invention provides a side-edge backlight module, which arranges the fluorescent powder layer to be spaced from the backlight source in order to extend the lifespan of the module and the backlight source, reduce the extent of color deviation and which also makes an end face of the bonding layer that is in contact engagement with the fluorescent powder layer a smooth continuous curved surface. The fluorescent powder layer is set along the curved surface so as to achieve more uniform distribution of light, elimination of light concentration spot, increase of homogenization of the light guide board, and reduce the number of LEDs used in a subsequent use of high Lumen LED so as to reduce the cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A side-edge backlight module, comprising a backlight source that emits blue light, a light guide board, and a fluorescent powder layer, the light guide board comprising a light incidence surface, the backlight source being set corresponding to the light incidence surface and arranged at one side of the light guide board, the fluorescent powder layer being mounted by a bonding layer to the light incidence surface of the light guide board, the bonding layer having an end face that is in contact engagement with the fluorescent powder layer and comprises a smooth continuous curved surface, the fluorescent powder layer being set along the curved surface, the fluorescent powder layer being excited by the blue light emitting from the backlight source to generate white light, the white light transmitting through the bonding layer to enter the light guide board;
wherein the backlight source comprises a circuit board and a plurality of LED chips that is arranged on the circuit board and is electrically connected to the circuit board to emit blue light, the plurality of LED chips being arranged to face the fluorescent powder layer.

2. The side-edge backlight module as claimed in claim 1, wherein the end face of the bonding layer that is in contact engagement with the fluorescent powder layer comprises a smooth continuous convex curved surface.

3. The side-edge backlight module as claimed in claim 1, wherein the end face of the bonding layer that is in contact engagement with the fluorescent powder layer comprises a smooth continuous concave curved surface.
